(19) United States
(12) Patent Application Publication
(10) Pub. No.: US 2015/0239301 A1
(43) Pub. Date: Aug. 27, 2015

(54) TYRE DESIGNED TO BE ABLE TO RUN FLAT, COMPRISING A HYBRID CARCASS PLY

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Solenne Vallet, Clermont-Ferrand (FR); Serge Lefebvre, Clermont-Ferrand (FR); Jean-Yves Denoueix, Clermont-Ferrand (FR); Jérémy Guillaumain, Clermont-Ferrand (FR)

(73) Assignees: COMPAGNIE GENERALE DES ETABLISSEMENTS MICHELIN, Clermont-Ferrand (FR); Michelin Recherche et Technique S.A., GRANGES-PACCOT (CH)

(21) Appl. No.: 14/431,400

(22) PCT Filed: Oct. 11, 2013
(86) PCT No.: PCT/EP2013/071260

§ 371 Date: Mar. 26, 2015

(30) Foreign Application Priority Data
Oct. 12, 2012 (FR) 1259756

(51) Int. Cl. B60C 17/00

(52) U.S. Cl. CPC B60C 17/00; B60C 17/0009; B60C 2017/0081

(57) ABSTRACT

A tyre, which is designed to be able to run flat, includes a carcass reinforcement. The carcass reinforcement includes at least one reinforcing element. Each reinforcing element includes at least one multifilament plied strand made of aramid and at least one multifilament plied strand made of polyester. The at least one multifilament plied strand made of aramid and the at least one multifilament plied strand made of polyester are twisted together.

The invention relates to a tyre designed to be able to run flat.

For several years, tyre manufacturers have sought to eliminate the need for the presence of a spare wheel on board the vehicle while at the same time guaranteeing that the vehicle will be able to continue its journey despite a significant or complete loss of pressure from one or more of the tyres. That for example allows a service centre to be reached without the need to stop, under circumstances that are often hazardous, in order to fit the spare wheel.

One envisaged solution is the use of tyres which are designed to be able to run flat and provided with self-supporting sidewalls (sometimes referred to by their English trade designations “ZP” for “zero pressure” or “SST” for “self supporting tyre”).

A tyre designed to be able to run flat and comprising a crown comprising a crown reinforcement, which reinforcement is formed of two crown plies of reinforcing elements and surmounted by a tread, is known from the prior art. Two sidewalls extend the crown radially inwards. These sidewalls are reinforced by rubber inserts that are able to support a load at reduced pressure or even with no pressure.

The tyre further comprises two beads each one comprising a bead wire and a carcass reinforcement extending from the beads through the sidewalls to the crown and comprising two carcass plies of reinforcing elements. One of the carcass plies is anchored to each of the beads by being turned up around the bead wire and the other carcass ply stops radially on the outside of the bead wire. The two carcass plies comprise textile reinforcing elements made of rayon.

When the inflation pressure is significantly reduced in comparison with the service pressure, or is even zero (this is then referred to as “run-flat” mode), the tyre needs to allow a given distance to be covered at a given speed. This performance, referred to as “EM” (extended mobility) running performance, is required by legislation or by motor manufacturers in order to allow the producer to advertize the tyre as being able to run flat.

When the inflation pressure is close to the service pressure (this is then referred to as “normal running” mode), it is desirable for the tyre to exhibit performance, referred to as “IM” (inflated mode) running performance, that is as good as possible. This IM running performance includes, amongst other things, the mass, the rolling resistance or even the comfort.

However, the self-supporting sidewalls give rise to significant losses in IM running performance, notably by comparison with a standard tyre that does not have self-supporting sidewalls. In particular, the mass of these inserts leads to an increase in the total mass of the tyre. Further, the addition of these inserts inevitably leads to an increase in the hysteresis and therefore to an increase in the rolling resistance. In addition, these inserts increase the rigidity of the sidewalls of the tyre, thus reducing the comfort of the tyre.

The subject of the invention is a tyre designed to be able to run flat providing the required EM running performance and offering IM running performance that is as close as possible to a standard tyre not provided with self-supporting sidewalls.

To this end, the subject of the invention is a tyre designed to be able to run flat comprising a carcass reinforcement comprising at least one reinforcing element comprising at least one (namely one or more than one) multifilament plied strand made of aramid and at least one (namely one or more than one) multifilament plied strand made of polyester which are twisted together.

The aramid-polyester hybrid reinforcing element means that use can be made of the different but complementing properties of each material. Specifically, the reinforcing element has a relatively low modulus at small deformations (in normal running mode), in this instance that of the polyester, which proves to be enough to provide the IM running performance. The reinforcing element has a relatively high modulus at high deformations (in run-flat mode), in this instance that of the aramid, which proves to be enough on its own to provide the EM running performance.

The combined use of aramid and polyester makes it possible to reduce the diameter of the reinforcing element because the tenacity of the aramid/polyester combination is better than that of rayon alone which has a force at break that is equivalent but for a higher count and therefore for a relatively large diameter. Thus a smaller amount of rubber is required to calender the aramid/polyester hybrid reinforcing elements as compared with reinforcing elements made of rayon. Reducing the mass of rubber makes it possible to reduce cost, mass and also hysteresis and therefore the rolling resistance of the tyre.

Furthermore, the invention makes it possible to dispense with the use of rayon, this being desirable for environmental and cost reasons.

Specifically, for preference, the diameter of the reinforcing element is less than or equal to 1.1 mm and more preferably less than or equal to 0.7 mm.

The reinforcing element is also referred to as a plied yarn. Each multifilament plied strand is also referred to as an overtwist and comprises a plurality of elementary filaments or monofilaments which may potentially be interlaced with one another. Each plied strand comprises between 50 and 2000 monofilaments.

It will be recalled that, as is well known, an aramid filament is a filament of linear macromolecules formed of aromatic groups joined together by aramid bonds at least 85% of which are directly bonded to two aromatic rings, and, more particularly, poly(p-phenylene terephthalamide) (or PPTA) fibres which have been manufactured for a very long time from optically anisotropic spinning compositions.

It will be recalled that, as is well known, a polyester filament means a filament of linear macromolecules formed of groups bonded together by ester bonds. Polyester is manufactured by polycondensation as an esterification reaction between a carboxylic diacid or derivative thereof and a diol. For example, polyethylene terephthalate can be manufactured by the polycondensation of terephthalic acid and ethylene glycol.

For preference, the tyres may be intended for motor vehicles of the passenger car, 4×4, “SUV” (sport utility vehicle) type.

Advantageously, the carcass reinforcement comprises one single carcass ply.

The combined use of aramid and polyester makes it possible to obtain a carcass ply that has mechanical strength, notably force at break, properties that are equivalent to or even higher than those of two carcass plies made of rayon. In addition, by reducing the number of carcass plies the cost, mass and also the hysteresis and therefore rolling resistance of the tyre are reduced.

The presence of a single carcass ply makes it possible to obtain a tyre the carcass reinforcement of which is more flexible than a tyre the carcass reinforcement of which comprises two carcass plies. Thus, the vertical stiffness of the tyre is reduced and the comfort thereof is improved, thus bringing it closer to the level of comfort of a standard tyre that does not have self-supporting sidewalls.

Optionally, the tyre comprises two beads each one comprising at least one annular reinforcing structure, the carcass reinforcement being anchored in each of the beads by being turned up around the annular reinforcing structure.

Advantageously, the tyre comprises a sidewall insert arranged axially on the inside of the carcass reinforcement.

According to certain optional features of the tyre:
The count of the multifilament plied strand made of aramid is comprised between 100 and 400 tex, endpoints included, preferably between 140 and 210 tex, endpoints included.
The count of the multifilament plied strand made of polyester is comprised between 100 and 500 tex, endpoints included, preferably between 100 and 170 tex, endpoints included.
The ratio of the count of the multifilament plied strand made of aramid to the count of the multifilament plied strand made of polyester is comprised between 0.2 and 4, preferably between 1 and 1.3.

According to other optional features of the tyre:
The twist of the multifilament plied strand made of aramid is comprised between 250 and 450 twists per metre, endpoints included, preferably between 340 and 420 twists per metre, endpoints included.
The twist of the multifilament plied strand made of polyester is comprised between 250 and 450 twists per metre, endpoints included, preferably between 340 and 420 twists per metre, endpoints included.

The twist of each plied strand is high enough that the reinforcing element has sufficient endurance. The twist is also low enough to obtain a high modulus and thus improve the EM running performance of the tyre.

The twist of the multifilament plied strand means the twist given to each multifilament plied strand during the step of final assembly of at least the two multifilament plied strands with one another in order to form the plied yarn that makes up the reinforcing element.
The elementary filaments that make up the multifilament plied strand made of aramid are twisted together with a twist factor of between 65 and 240, endpoints included, preferably between 105 and 160, endpoints included.
The elementary filaments that make up the multifilament plied strand made of polyester are twisted together with a twist factor of between 65 and 240, endpoints included, preferably between 90 and 150, endpoints included.

It will be recalled here that, in a reinforcing element, the twist factor of a multifilament plied strand (or more precisely of the elementary filaments that make up the said plied strand) can be expressed according to the following relationship:

K=(twist in twists/metre)×[(count of the plied strand (in tex)/(1000·ρ)]^{1/2}

in which the twist of the multifilament plied strand is expressed in twists per metre of reinforcing element, the count of the plied strand is expressed in tex (weight in grams of 1000 metres of plied strand), and finally ρ is the density or mass per unit volume (in g/cm³) of the material of which the plied strand is made (approximately 1.44 for aramid, 1.25 to 1.40 for polyesters and 1.38 for PET).

According to other optional features of the tyre:
The initial tensile modulus of the reinforcing element, measured at 20° C., is greater than or equal to 5.5 cN/tex, preferably comprised between 6.5 and 7.9 cN/tex, endpoints included. Such an initial modulus makes it possible, in normal running mode in which deformations are the smallest, to obtain a reinforcing element that offers high mechanical strength, in this instance that of polyester. In addition, the behaviour of the tyre is improved, notably tyre steering performance. Such a modulus also makes it possible to limit the deformation of the tyre in the raw state when it is placed in the mould before curing.
The final tensile modulus of the reinforcing element, measured at 20° C., is greater than or equal to 10 cN/tex, preferably comprised between 13.5 and 16.5 cN/tex, endpoints included. Such a modulus makes it possible, in run-flat mode in which deformations are the greatest, to obtain a reinforcing element that offers high mechanical strength, in this instance that of aramid. This final modulus also makes it possible to compensate for the loss of mechanical strength caused by the degradation of the polyester with these deformations which generally occur at high temperatures.
The ratio of the final tensile modulus of the reinforcing element to the initial tensile modulus of the reinforcing element, both measured at 20° C., is less than or equal to 3, preferably comprised between 1.7 and 2.5, endpoints included.
The initial tensile modulus of the reinforcing element, measured at 180° C., is greater than or equal to 1.5 cN/tex, preferably comprised between 1.9 and 2.3 cN/tex, endpoints included.
The force at break of the reinforcing element is greater than or equal to 20 daN, preferably greater than or equal to 25 daN, more preferably greater than or equal to 30 daN. The higher the force at break, the better its resistance to attacks of the “road hazard” type notably including potholes and kerbing. Such a force at break therefore makes it possible to obtain a tyre that has high resistance to attacks of the “road hazard” type.
The thermal shrinkage of the reinforcing element after 2 minutes at 185° C. under a tensile preload of 0.5 cN/tex is less than or equal to 1.2%. Such a thermal shrinkage makes it possible to obtain a relatively high elongation-at-break value for an aramid/polyester reinforcing element. The tyre is therefore less sensitive to attacks of the “road hazard” type.
As an alternative, the thermal shrinkage of the reinforcing element after 2 minutes at 185° C. under a tensile preload of 0.5 cN/tex is greater than 1.2%. Such a thermal shrinkage makes it possible to obtain a higher initial modulus and therefore greater mechanical resistance to light loadings.

All the mechanical properties listed hereinabove are well known to those skilled in the art and most deduced from the force-elongation curves.

For preference, the reinforcing element comprises a single multifilament plied strand made of aramid and a single multifilament plied strand made of polyester. Such a reinforcing element allows the tyre to be given excellent EM and IM running performance. This is because, thanks to its two multifilament plied strands, the size of the reinforcing element and therefore the weight and rolling resistance of the tyre are limited.

For preference, each plied strand is helically wound around the other.

Advantageously, the polyester is selected from polyethylene terephthalate (PET), polyethylene naphthalate (PEN), polybutylene terephthalate (PBT), polybutylene naphthalate (PBN), polypropylene terephthalate (PPT) or polypropylene naphthalate (PPN), and the polyester is preferably polyethylene terephthalate (PET).

The invention will be better understood from reading the description which follows, given solely by way of nonlimiting example and made with reference to the drawings in which:

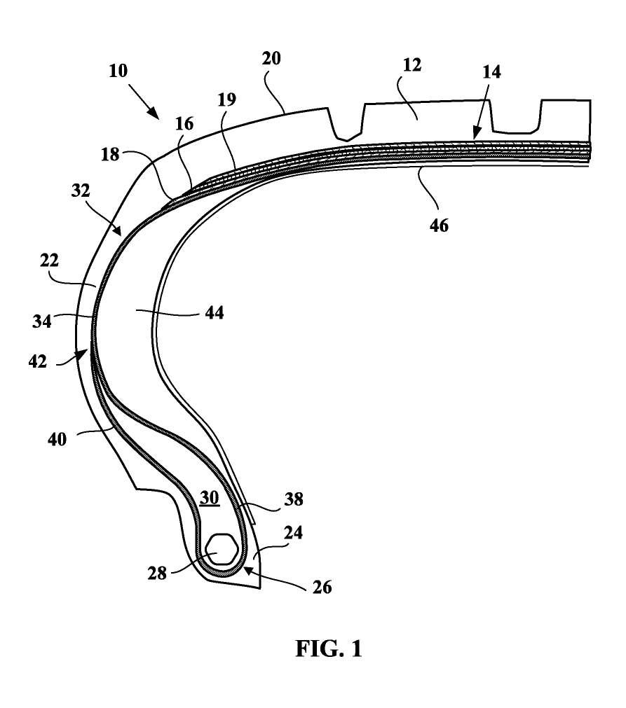

FIG. 1 is a view in radial cross section of a tyre designed to be able to run flat according to a first embodiment of the invention;

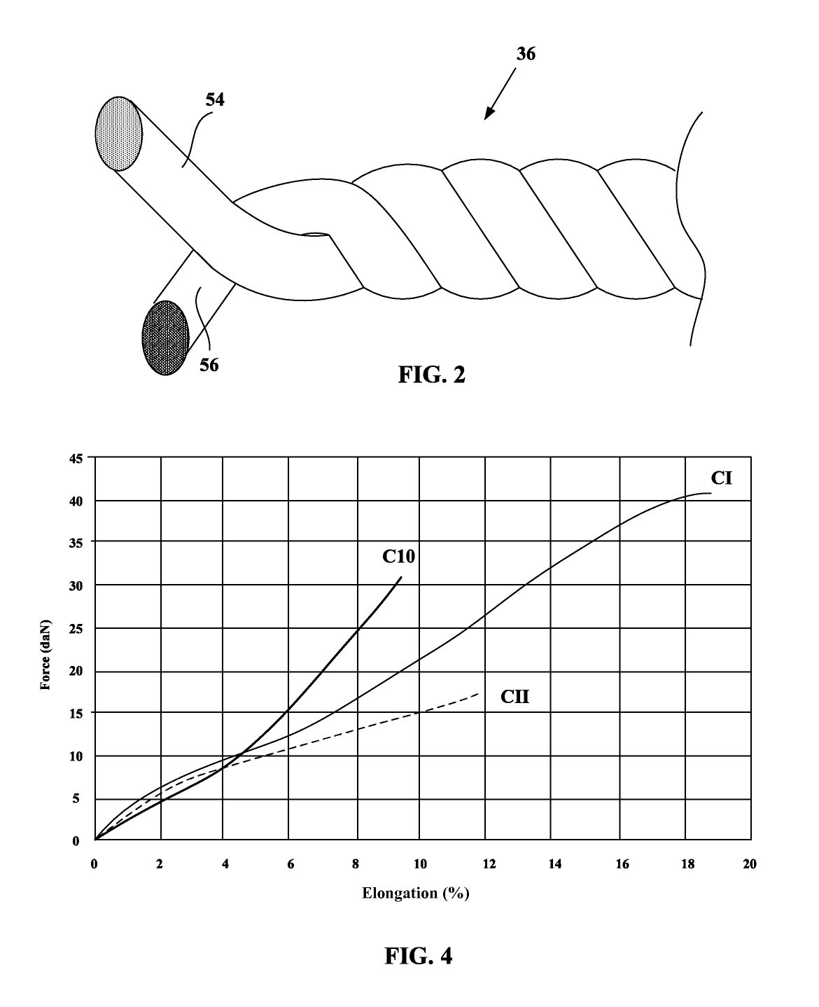

FIG. 2 illustrates a view of details of a reinforcing element of the tyre of FIG. 1;

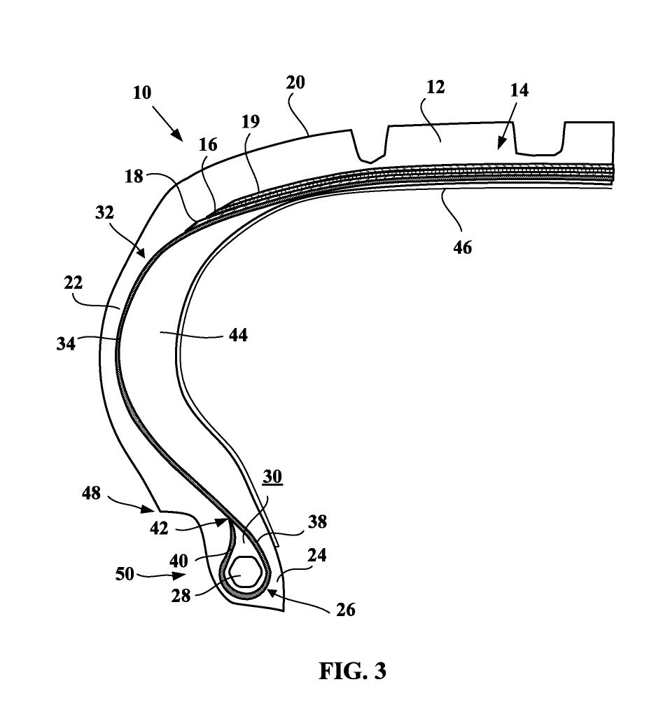

FIG. 3 is a view similar to that of FIG. 1, of a tyre according to a second embodiment; and

FIG. 4 depicts force-elongation curves for various reinforcing elements.

When using the term “radial” it is appropriate to make a distinction between the various different uses made of this word by those skilled in the art. Firstly, the expression refers to a radius of the tyre. It is in this sense that a point A is said to be “radially inside” a point B (or “radially on the inside of” the point B) if it is closer to the axis of rotation of the tyre than is the point B. Conversely, a point C is said to be “radially outside” a point D (or “radially on the outside of” the point D) if it is further away from the axis of rotation of the tyre than is the point D. Progress will be said to be “radially inwards (or outwards)” when it is in the direction towards smaller (or larger) radii. It is this sense of the term that applies also when matters of radial distances are being discussed.

By contrast, a reinforcing element or a reinforcement is said to be “radial” when the reinforcing element or the reinforcing elements of the reinforcement make an angle greater than or equal to 65° and less than or equal to 90° with the circumferential direction.

Finally, a “radial section” or “radial cross section” here means a section or cross section on a plane containing the axis of rotation of the tyre.

An “axial” direction is a direction parallel to the axis of rotation of the tyre. A point E is said to be “axially inside” a point F (or “axially on the inside of” the point F) if it is closer to the mid-plane of the tyre than is the point F. Conversely, a point G is said to be “axially outside” a point H (or “axially on the outside of” the point H) if it is further away from the mid-plane of the tyre than is the point H.

The “mid-plane” of the tyre is the plane which is perpendicular to the axis of rotation of the tyre and which lies equal distances from the annular reinforcing structures of each bead.

A “circumferential” direction is a direction which is perpendicular both to a radius of the tyre and to the axial direction.

### EXAMPLES OF A TYRE ACCORDING TO THE INVENTION

FIG. 1 depicts schematically in radial section a tyre according to a first embodiment of the invention and denoted by the general reference 10. The tyre 10 is of the run-flat type. The tyre 10 is for a passenger car.

This tyre 10 comprises a crown 12 comprising a crown reinforcement 14 formed of two crown plies of reinforcing elements 16, 18 and of a hooping ply 19. The crown reinforcement 14 is surmounted by a tread 20. In this instance, the hooping ply 19 is arranged radially on the outside of the plies 16, 18, between the plies 16, 18 and the tread 20. Two self-supporting sidewalls 22 extend the crown 12 radially towards the inside.

The tyre 10 further comprises two beads 24 radially on the inside of the sidewalls 22 and each comprising an annular reinforcing structure 26, in this instance a bead wire 28, surmounted by a mass of bead apex rubber 30, and a radial carcass reinforcement 32.

The carcass reinforcement 32 preferably comprises a single carcass ply 34 of reinforcing elements 36, the ply 34 being anchored to each of the beads 24 by a turnup around the bead wire 28, so as to form, within each bead 24, a main strand 38 extending from the beads through the sidewalls towards the crown, and a turnup 40, the radially outer end 42 of the turnup 40 being substantially midway up the height of the tyre. The carcass reinforcement 32 extends from the breads 24 through the sidewalls 22 towards the crown 12.

The rubber compositions used for the crown plies 16, 18 and carcass ply 34 are conventional compositions for the calendering of reinforcing elements, typically based on natural rubber, carbon black, a vulcanizing system and the usual additives. When the reinforcing elements are made of textile, particularly in this instance in the carcass reinforcement, adhesion between the textile reinforcing element and the rubber composition with which it is coated is ensured for example by a usual glue of the RFL type.

The tyre 10 also comprises two sidewall inserts 44, axially on the inside of the carcass reinforcement 32. These inserts 44 with their characteristic crescent-shaped radial cross section are intended to reinforce the sidewall. They comprise at least one polymer composition, preferably a rubber compound. Document WO 02/096677 provides a number of examples of rubber compounds that can be used to make such an insert. Each sidewall insert 44 is liable to contribute to supporting a load corresponding to part of the weight of the vehicle in a run-flat situation.

The tyre also comprises an airtight internal layer 46, preferably made of butyl, situated axially on the inside of the sidewalls 22 and radially on the inside of the crown reinforcement 14 and extending between the two beads 24. The sidewall inserts 44 are situated axially on the outside of the internal layer 46. Thus, the sidewall inserts 44 are arranged axially between the carcass reinforcement 32 and the internal layer 46.

The carcass ply 34 comprises textile reinforcing elements 36 one of which is illustrated in FIG. 2. The reinforcing elements 36 are mutually parallel. Each reinforcing element 36 is radial. In other words, each reinforcing element 36 extends in a plane substantially parallel to the axial direction of the tyre 10.

Each reinforcing element 36 comprises a multifilament plied strand 54 made of aramid, in this instance a single plied strand, and a multifilament plied strand 56 made of polyester, in this instance a single plied strand, which are individually overtwisted at 380 twists/metre then twisted together at 380 twists/metre. The two plied strands are wound in a helix one around the other.

The polyester is selected from polyethylene terephthalate, polyethylene naphthalate, polybutylene terephthalate, polybutylene naphthalate, polypropylene terephthalate or polypropylene naphthalate. In this instance, the polyester is polyethylene terephthalate (PET).

The count of the multifilament plied strand 54 made of aramid is comprised between 100 and 400 tex, endpoints included, preferably between 140 and 210 tex, endpoints included. In this instance, the count of the multifilament plied strand 54 made of aramid is equal to 167 tex.

The count of the multifilament plied strand 56 made of polyester is comprised between 100 and 500 tex, endpoints included, preferably between 100 and 170 tex, endpoints included. In this instance, the count of the multifilament plied strand 56 made of polyester is equal to 144 tex.

The ratio of the count of the multifilament plied strand 54 made of aramid to the count of the multifilament plied strand 56 made of polyester is comprised between 0.2 and 4, preferably between 1 and 1.3 and in this instance is equal to 1.16.

The twist of the multifilament plied strand 54 made of aramid is comprised between 250 and 450 twists per metre, endpoints included, preferably between 340 and 420 twists per metre, endpoints included. In this instance, the twist of the multifilament plied strand 54 made of aramid is equal to 380 twists per metre.

The twist of the multifilament plied strand 56 made of polyester is comprised between 250 and 450 twists per metre, endpoints included, preferably between 340 and 420 twists per metre, endpoints included. In this instance, the twist of the multifilament plied strand 56 made of polyester is equal to 380 twists per metre.

The reinforcing element therefore has plied strands that have substantially the same twist. This then is a twist-balanced plied strand.

The elementary filaments of which the multifilament plied strand 54 made of aramid is composed are twisted with a twist factor K1 comprised between 65 and 240, endpoints included, preferably between 105 and 160, endpoints included. In this instance, K1=129.

The elementary filaments of which the multifilament plied strand 56 made of polyester is composed are twisted with a twist factor K2 comprised between 105 and 160, endpoints included, preferably between 90 and 150, endpoints included. In this instance, K2=123.

The ratio K1/K2 between the twist factors is advantageously comprised between 0.9 and 1.10, endpoints included.

The initial tensile modulus Mi20 of the reinforcing element 36, measured at 20° C., is greater than or equal to 5.5 cN/tex, preferably comprised between 6.5 and 7.9 cN/tex, endpoints included. In this instance, Mi20=7.2 cN/tex.

The final tensile modulus Mf20 of the reinforcing element 36, measured at 20° C., is greater than or equal to 10 cN/tex, preferably comprised between 13.5 and 16.5 cN/tex, endpoints included. In this instance, Mf20=15 cN/tex.

The ratio of the final modulus Mf20 to the initial modulus Mi20, both measured at 20° C., is less than or equal to 3, preferably comprised between 1.7 and 2.5, endpoints included. In this instance, Mf20/Mi20=2.1.

The initial tensile modulus Mi180 of the reinforcing element, measured at 180° C., is greater than or equal to 1.5 cN/tex, preferably comprised between 1.9 and 2.3 cN/tex, endpoints included. In this instance, Mi180=2.1 cN/tex.

The force at break of the reinforcing element 36 is greater than or equal to 20 daN, preferably greater than or equal to 25 daN, and more preferentially greater than or equal to 30 daN. In this instance, Fr=34 daN.

The thermal shrinkage CT of the reinforcing element 36 after 2 minutes at 185° C., under a tensile preload of 0.5 cN/tex, is less than or equal to 1.2%. In this instance, CT=0.8%.

The values described hereinabove are measured on as-manufactured reinforcing elements or alternatively those taken from reinforcing plies. As an alternative, the values described hereinabove are measured on reinforcing elements taken from a tyre.

In order to manufacture the reinforcing elements 36 by twisting, it will be recalled here simply, as is well known to those skilled in the art, that each plied strand of which the final reinforcing element is made is first of all twisted individually on itself in a given direction (for example a Z-twist of 380 twists per metre of plied strand) during a first step to form an overtwist, then that the plied strands thus twisted on themselves are then twisted together in the opposite direction (for example an S-twist of 380 twists per metre of reinforcing element) to form a plied yarn, in this instance the final reinforcing element 36.

FIG. 3 depicts a tyre according to a second embodiment of the invention. Elements analogous to those of the first embodiment are denoted by the same references.

Unlike the tyre 10 of the first embodiment, the tyre 10 according to the second embodiment is of the type with a shortened turnup. The radially outer end 42 of the turnup 40 is radially on the inside of the end 48, radially furthest toward the outside of the bead 24, of the part 50 of the bead 24 that is intended to press against the rim flange.

### COMPARATIVE TESTS AND MEASUREMENTS

Characteristics of the reinforcing element 36 of the tyre 10 according to the invention and of reinforcing elements of other tyres are compared in table 1.

The tyre 10 is in accordance with the invention and as described hereinabove.

The tyre I is of the standard type not provided with self-supporting sidewalls and comprises a carcass reinforcement comprising a single carcass ply. The carcass ply comprises textile reinforcing elements. Each reinforcing element comprises two multifilament plied strands made of PET which are twisted together.

The tyre II is designed to be able to run flat and comprises a carcass reinforcement comprising two carcass plies. Each carcass ply comprises textile reinforcing elements. Each reinforcing element comprises two multifilament plied strands made of rayon which are twisted together.

All of the mechanical properties indicated are measured on coated textile reinforcing elements (namely those that are ready for use or those that have been extracted from the tyre that they reinforce) having undergone prior conditioning; what is meant by “prior conditioning” is that the cords (after drying) have been stored for at least 24 hours prior to measurement in a standard atmosphere in accordance with European standard DIN EN 20139 (temperature of 20±2° C.; relative humidity of 65±2%).

The count (or linear density) of the elementary plied strands or of the reinforcing elements is determined on at least two test specimens, each corresponding to a length of at least 5 m, by weighing this length; the count is given in tex (weight in grams of 1000 m of product—remember: 0.111 tex is equal to 1 denier).

The mechanical properties are measured in a known way using an “INSTRON” tensile tester fitted with “4D” grippers. The test specimens tested are subjected to tension over an initial length of 400 mm at a nominal rate of 200 mm/min, under a standard tensile preload of 0.5 cN/tex. All the results given are an average over five measurements.

The force at break and elongation at break measurements (total elongation in %) are conducted under tension in accordance with ISO 6892:1984, these also making it possible to obtain the force-elongation curves.

The initial modulus is defined as the gradient at the origin of the linear part of the force-elongation curve which occurs just after a standard tensile preload of 0.5 cN/tex. The final modulus is defined as the gradient at the point corresponding to 80% of the force at break of the force-elongation curve.

The force-elongation curves CI, CII and C10 for various tyres I, II of the prior art and for the tyre 10 according to the invention are depicted in FIG. 4.

TABLE 1

| | Tyre | | |
|---|---|---|---|
| | I | II | 10 |
| Force-elongation curve | CI | CII | C10 |
| Nature of the plied strands | PET/PET | Rayon/ | Aramid/PET |
| | | Rayon | |
| Counts of the plied strands (tex) | 334/334 | 184/184 | 167/144 |
| Twists of the plied strands | 270/270 | 480/480 | 380/380 |
| (twists/m) | | | |
| Diameter (mm) | 0.96 | 0.68 | 0.65 |
| Twist factor K1 | 133 | 170 | 129 |
| Twist factor K2 | 133 | 170 | 123 |
| Force at break (daN) | 40 | 17 | 34 |
| Thermal shrinkage at 185° C. (%) | 0.8 | 0 | 0.8 |
| Initial modulus at 20° C. (cN/tex) | 5.1 | 7.2 | 7.2 |
| Final modulus at 20° C. (cN/tex) | NA | NA | 15 |
| Glass transition temperature (° C.) | 110 | NA | NA/110 |
| Melting point (° C.) | 260 | NA | NA/260 |
| Decomposition temperature (° C.) | ~350 | ~350 | ~450/~350 |

The caption NA (not applicable) means that the value does not exist or has no significance.

The PET is marketed by the company Performance Fibers under the name 1X50. The rayon is marketed by the company Cordenka under the name Super 3—T700. Finally, the aramid is marketed by the company Teijin under the name Twaron 1000.

The PET has a relatively low melting point which gives it poor thermal stability unlike rayon or aramid which have little or no thermal sensitivity. Thus, in run-flat mode, i.e. when the temperature is high (because of the heating caused by the loss of pressure), the PET breaks down very rapidly and no longer performs its reinforcing function. By contrast, the aramid, because of its great thermal stability, performs its reinforcing function even at high temperature.

FIG. 4 shows that the reinforcing element 36 (curve C10) has a force at break and a rigidity to high deformations that are superior to that of the reinforcing element made of rayon (curve CII). In addition, the reinforcing element 36 (curve C10) has a rigidity to high deformations that is superior to that of the reinforcing element made of PET (curve CI). Thus, in run-flat mode, the reinforcing element 36 is able to offer a structural rigidity superior to that of the reinforcers made of PET and of rayon, notably in a zone joining the crown and the sidewalls of the tyre, known as the shoulder zone, and in a zone of the sidewall near to the bead, referred to as the bottom zone. Thus, the reinforcing element made of rayon gives the tyre 10 better IM running performance than the tyre II.

The IM running performance and the EM running performance of the tyres I, II and 10 are compared in table 2.

### Mass of the Tyre

The value of the mass is indicated in relative units (base 100) in relation to the mass of the tyre I of the prior art. The higher the mass in comparison with that of the tyre I of the prior art, the greater the extent to which the value is lower than 100.

### Rolling Resistance

The rolling resistance is measured, after a thermal stabilization step, from measuring the deceleration of a wheel provided with the tested tyre pressed against a test rolling road. The load applied is equal to 85% of the ETRTO (European Tyre and Rim Technical Organisation) load.

The rolling resistance value is indicated in relative units (base 100) in relation to the rolling resistance of the tyre I of the prior art. The higher the rolling resistance in comparison with that of the tyre I of the prior art, the greater the extent to which the value is lower than 100.

### Comfort

Comfort is determined from a vertical firmness measurement. The vertical firmness measurement is carried out on a wheel comprising a dynamometric hub on which the tested tyre is mounted. The wheel is pressed against a test rolling road under a load equal to 80% of the ETRTO load. The rolling road comprises a bar acting as an obstacle. The vertical firmness of the tyre is determined from the force measured by the dynamometric hub. The higher the force, the greater the vertical firmness and the lower the perception of comfort.

The vertical firmness value is indicated in relative units (base 100) in relation to the vertical firmness of the tyre I of the prior art. The lower the vertical firmness in comparison with that of the tyre I of the prior art and therefore the better the comfort, the closer the value is to 100.

### Run-Flat Test

The run-flat test is carried out in accordance with UNECE regulation 30. A value of 0 indicates that the tested tyre failed the run-flat test. A value of 1 indicates that the tested tyre successfully passed the run-flat test.

TABLE 2

| | Tyre | | |
|---|---|---|---|
| | I | II | 10 |
| Mass of tyre | 100 | 73 | 80 |
| Rolling resistance | 100 | 94 | 98 |
| Shock-absorption | 100 | 92 | 95 |
| Run-flat test | 0 | 1 | 1 |

The results of table 2 indicate that the tyre 10 according to the invention provides the required EM running performance (value of 1 for the run-flat test) and, of the tyres designed to be able to run flat (tyres II and 10), has the IM running performance closest to the standard tyre I. Although its IM running performance is inferior to that of the standard tyre I, tyre 10 according to the invention has IM running performance superior to that of tyre II.

The invention is not restricted to the embodiments described hereinabove.

Specifically, the carcass reinforcement 32 of the tyre may comprise two carcass plies 34.

An embodiment may also be conceived of in which the turnup 40 extends up between the crown ply 18 and the main strand 38.

An embodiment may also be conceived of in which the carcass reinforcement comprises an auxiliary reinforcing element extending between the bead 24 and the crown 12 of the tyre. This auxiliary reinforcing element is interposed between the main strand 38 and the turnup 40 and extends up between the crown ply 18 and the main strand 38.

These two embodiments above are particularly advantageous in instances in which the tyre comprises a single carcass ply, the turnup 40 or the auxiliary reinforcing element providing additional reinforcement in the shoulder zone of the tyre.

Furthermore, each multifilament plied strand may have a twist different from that of the other multifilament plied strand or strands so as to obtain a reinforcing element that is not twist balanced.

The features of the various embodiments described or provided for hereinabove may also be combined, provided that they are mutually compatible.

1-10. (canceled)

11. A tyre designed to be able to run flat, the tyre comprising:
a carcass reinforcement that includes at least one reinforcing element,
wherein each reinforcing element includes:
at least one multifilament plied strand made of aramid, and
at least one multifilament plied strand made of polyester, and
wherein the at least one multifilament plied strand made of aramid and the at least one multifilament plied strand made of polyester are twisted together.

12. The tyre according to claim 11, wherein the carcass reinforcement includes a single carcass ply.

13. The tyre according to claim 11, further comprising two beads, each bead including at least one annular reinforcing structure, wherein the carcass reinforcement is anchored in the two beads by being turned up around the at least one annular reinforcing structure of each bead.

14. The tyre according to claim 12, further comprising two beads, each bead including at least one annular reinforcing structure, wherein the carcass reinforcement is anchored in the two beads by being turned up around the at least one annular reinforcing structure of each bead.

15. The tyre according to claim 11, further comprising a sidewall insert arranged axially at an inside position relative to the carcass reinforcement.

16. The tyre according to claim 11, wherein a count of each multifilament plied strand made of aramid is between 100 and 400 tex, endpoints included.

17. The tyre according to claim 16, wherein the count of each multifilament plied strand made of aramid is between 140 and 210 tex, endpoints included.

18. The tyre according to claim 11, wherein a count of each multifilament plied strand made of polyester is between 100 and 500 tex, endpoints included.

19. The tyre according to claim 18, wherein the count of each multifilament plied strand made of polyester is between 100 and 170 tex, endpoints included.

20. The tyre according to claim 11, wherein a ratio of a count of each multifilament plied strand made of aramid to a count of each multifilament plied strand made of polyester is between 0.2 and 4.

21. The tyre according to claim 20, wherein the ratio of the count of each multifilament plied strand made of aramid to the count of each multifilament plied strand made of polyester is between 1 and 1.3.

22. The tyre according to claim 11, wherein a twist of each multifilament plied strand made of aramid is between 250 and 450 twists per meter, endpoints included.

23. The tyre according to claim 22, wherein the twist of each multifilament plied strand made of aramid is between 340 and 420 twists per meter, endpoints included.

24. The tyre according to claim 11, wherein a twist of each multifilament plied strand made of polyester is between 250 and 450 twists per meter, endpoints included.

25. The tyre according to claim 24, wherein the twist of each multifilament plied strand made of polyester is between 340 and 420 twists per meter, endpoints included.

26. The tyre according to claim 11, wherein each reinforcing element includes a single multifilament plied strand made of aramid and a single multifilament plied strand made of polyester.
